(19) United States
(12) Patent Application Publication
(10) Pub. No.: US 2023/0171677 A1
(43) Pub. Date: Jun. 1, 2023

(54) TRANSMITTER ACTIVATION BASED ON RADIO SCANS

(71) Applicant: Hewlett-Packard Development Company, L.P., Spring, TX (US)

(72) Inventors: Isaac Lagnado, Spring, TX (US); Steven Petit, Spring, TX (US); Danny Farnyih Meng, Spring, TX (US); Mats Anders Krister Luckman, Spring, TX (US); Chih-Hung Chien, Taipei City (TW); Christopher Charles Mohrman, Spring, TX (US)

(21) Appl. No.: 17/536,394

(22) Filed: Nov. 29, 2021

(51) Int. Cl. H04W 48/16; H04W 4/02

(52) U.S. Cl. CPC H04W 48/16; H04W 4/027

(57) ABSTRACT

In some examples, the disclosure describes a device that includes a radio device, a transmitter, and a processor to: instruct the radio device to perform a radio scan of an area, compare the radio scan to a previous radio scan by the radio device, determine an acceleration of the device based on the comparison, and activate the transmitter in response to the acceleration being below a threshold acceleration.

### BACKGROUND

Computing devices are utilized to perform particular functions. In some examples, computing devices utilize battery power that is limited when the computing device is not connected to an electrical power source. In some examples, computing devices are mobile computing devices that are carriable or moveable from a first location to a second location.

### BRIEF DESCRIPTION OF THE DRAWINGS

FIG. 1 illustrates an example of a method for transmitter activation based on radio scans.

FIG. 2 illustrates an example of a method for transmitter activation based on radio scans.

FIG. 3 illustrates an example of a method for transmitter activation based on radio scans.

FIG. 4 illustrates an example of a computing device for determining device locations.

FIG. 5 illustrates an example of a memory resource for determining device locations.

FIG. 6 illustrates an example of a system for determining device locations.

### DETAILED DESCRIPTION

A user may utilize a computing device for various purposes, such as for business and/or recreational use. As used herein, the term computing device refers to an electronic device having a processor and a memory resource. Examples of computing devices include, for instance, a laptop computer, a notebook computer, a desktop computer, an all-in-one (AIO) computing device, and/or a mobile device (e.g., a smart phone, tablet, personal digital assistant, smart glasses, a wrist-worn device, etc.), among other types of computing devices.

Computing devices that are mobile devices may utilize different settings and/or perform different functions when at different locations. For example, the computing device may have a first set of restrictions or permissions within the first location and a second set of restrictions or permissions in the second location. In some examples, a particular location may have corresponding restrictions on functions of the computing device. For example, an airplane includes wireless transmission restrictions for computing devices when the airplane is moving.

In some examples, a computing device is utilized as an internet of things (IoT) device. As used herein, an IoT device includes a device within a system of interrelated, internet-connected devices that are able to collect and transfer data over a network without human intervention. In some examples, the computing device may have a user associated with the computing device and utilized by a user during a user mode. In these examples, the computing device can be altered from the user mode to an IoT mode where the computing device operates as an IoT device within an IoT system to transmit data and/or receive data. In other examples, the user may utilize the computing device within user mode while the device is also operating as an loT device.

In these examples, a user and/or user interface of the computing device may not be able to access an activation or deactivation function for the transmitter that is utilized to provide data (e.g., data provided to the IoT system, etc.) during the IoT mode of the computing device. However, the transmitter communication are in violation of wireless transmissions while on an airplane or other restricted area. In this way, the computing device may not be utilized while within the restricted area or during an airplane flight when the IoT transmitter is activated.

Thus, determining when the computing device is within a restricted area, such as an airplane, allows the computing device to deactivate the transmitter without user interaction. In a similar way, the transmitter is activated when it is determined that the computing device is outside the restricted area or no longer on the airplane. In this way, the transmitter is restricted from being activated or deactivated by an end user of the computing device. In some examples, the transmitter and/or information collected from the computing device during the IoT mode of the computing device is controlled by a third party or remote management device that is different than the user of the computing device. For example, the computing device may be owned by an organization and provided to the user for work use associated with the organization. In this example, the organization may control the transmitter remotely from the computing device and may not provide the user access to control the functions of the transmitter.

The present disclosure relates to transmitter activation and/or deactivation based on radio scans. As described herein, the activation and deactivation of a transmitter of a computing device may be inaccessible to a user of the computing device. In these examples, the transmitter is activated and/or deactivated based on scan data performed by a cellular radio device or global positioning system (GPS) receiver. In some examples, the cellular radio scan provides signal strength information that is compared to a previous radio scan that is used to determine a velocity. In these examples, the velocity is utilized to determine when the computing device is on a transportation vehicle that may have wireless transmission restrictions (e.g., airplane, high-speed train, etc.). In other examples, the GPS receiver determines a geographic location, altitude, and/or velocity of the computing device. In these examples, the IoT transmitter is activated or deactivated based on the determined geographic location, altitude, and/or velocity.

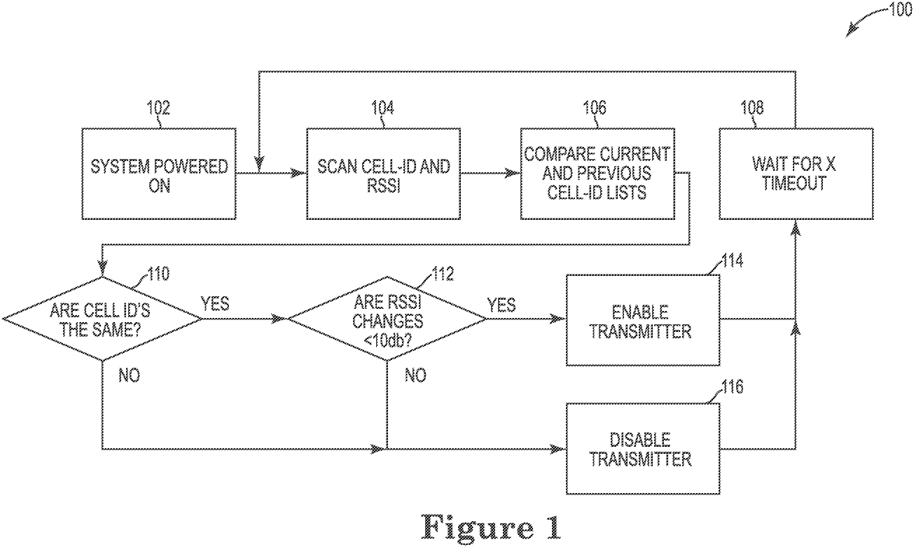

FIG. 1 illustrates an example of a method 100 for transmitter activation based on radio scans. In some examples, the method 100 is performed by a computing device or system. For example, the method 100 illustrates instructions or functions that are stored on a memory resource and executed by a processor. In some examples, the method begins when the system is powered on at 102. In some examples, the system is powered on or activated when power is provided to a computing device or computing system. In these examples, the computing device is activated or powered on to provide functions to a user and/or activated as an IoT device.

In some examples, the method 100 includes scanning cellular identifications (cell IDs) and signal strength (e.g., received signal strength indicator (RSSI), etc.) for surrounding devices. As used herein, a cellular scan includes a scan to determine a presence of other cellular towers in the area. In some examples, the cellular scan is used to identify a plurality of cellular devices within a particular threshold distance from the computing device. The cellular scan identifies the cell IDs for a plurality of static devices (e.g., cellular towers, access points, etc.) and/or a signal strength associated between the cellular radio device and the plurality of static devices.

In some examples, the cell IDs include identification names or numbers associated with the surrounding cellular devices within an area. For example, the cell IDs correspond to cellular towers that provide cellular communication to cellular devices (e.g., computing device, smart phones, cell phones, etc.). In some examples, the cell IDs correspond to particular cellular devices that are positioned at a fixed geographic location. For example, the cell IDs correspond to cellular towers that are located at fixed geographic locations that are identified based on the cell IDs.

In some examples, the method 100 includes comparing the cellular scan data to previous cellular scan data. In some examples, the previous cellular scan data is collected by the same device and/or the same cellular radio as the scan performed at 104. In some examples, the previous cellular scan data is performed a period of time prior to the cellular scan performed at 104. In some examples, the comparison is utilized to determine whether the cellular IDs are the same at 110. In some examples, the cellular IDs are the same when there is a complete match between the cellular IDs of the surrounding cellular devices between a current cellular scan and the previous cellular scan. In some examples, the cellular IDs are the same when a threshold quantity of cellular IDs are the same between a current cellular scan and the previous cellular scan.

In some examples, a match between the cellular IDs of a current cellular scan and a previous cellular scan indicates that the device has not moved from a location of the previous scan. In some examples, a mismatch or determination that the cellular IDs are not the same can indicate that the device has moved or is currently moving. In some examples, the mismatch or determination that the cellular IDs are not the same can indicate that the device is moving at a particular velocity or within a range of velocities. In some examples, the particular velocity indicates that the device may be on a vehicle that restricts wireless transmissions such as an airplane or high-speed train. In these examples, the method 100 disables the transmitter at 116.

In some examples, the method 100 disables a transmitter utilized as an internet of things (IoT) transmitter of the device. In some examples, the transmitter is the same cellular radio utilized to perform the cellular scan at 104. In some examples, the transmitter is utilized to transmit data and/or information related to the device to a remote device without user interaction. As described herein, the device may be provided to a user by an organization. In this way, the organization is able to monitor the device and/or receive information associated with the device while the user utilizes the device. In some examples, the organization is capable of monitoring the health of the device without the user having to provide the information. In these examples, a user may not have access to enable or disable the transmitter.

The method 100 includes determining whether the signal strength has changed above or below a threshold value when the cell IDs are determined to be the same or when there is a complete match between the cell IDs of a current scan and a previous scan. In some examples, the signal strength (e.g., RSSI, etc.) between the transmitter and the plurality of cellular devices is determined through the cellular scan. In these examples, the difference between the signal strength of the current scan and the previous scan is calculated for each of the plurality of cellular devices. In some examples, the calculated difference is compared to a threshold difference to determine a velocity of the device or velocity range of the device. In some examples, the threshold difference can be utilized to indicate whether the device is traveling at a velocity above a threshold velocity. In some examples, the threshold velocity can be utilized to indicate whether the device is traveling on a vehicle that restricts cellular transmissions.

In some examples, the method 100 enables the transmitter or activates the transmitter when the difference of the signal strength is below a threshold difference at 114. In some examples, the method 100 disables the transmitter at 116 when the difference of the signal strength is above a threshold difference. In some examples, the method 100 can wait for a time period at 108. In some examples, the time period can be utilized to calculate the velocity. For example, the time period can be utilized with the signal strength differences and/or cellular ID differences to determine a quantity of time that has passed between a current scan and a previous scan.

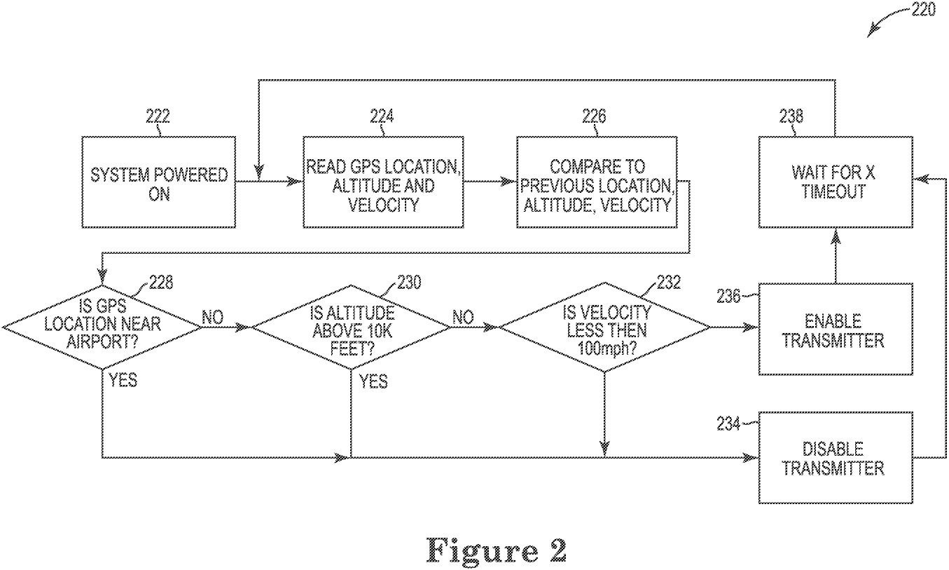

FIG. 2 illustrates an example of a method 220 for transmitter activation based on radio scans. In some examples, the method 220 is executed by a computing device. For example, the method 220 can represent instructions that are stored on a memory resource and executed by a processor to perform the corresponding functions of the method 220. In some examples, the method 220 is able to enable (e.g., activate, turn on, etc.) and disable (e.g., deactivate, turn off, etc.) a transmitter (e.g., transmitter utilized to provide data to an IoT system, etc.) without user interaction.

In some examples, the method 220 includes powering on the system of a device at 222. Powering on the system of the device includes providing electrical power to the device and/or activating an operating system of the device. In some examples, the device is activated and operating in a user mode or IoT mode. In some examples, the user mode corresponds to a user interface receiving inputs from user and the IoT mode corresponds to information provided through a transmitter without user interactions or interactions by a user through the user interface. As described herein, the user interface of the device may not provide access to enabling or disabling the transmitter utilized to provide data to an IoT netowrk. In this way, a user of the device may not be able to disable the transmitter to avoid providing information to an organization that provided the device to the user.

In some examples, the method 220 includes determining a GPS location, altitude, and velocity of the device through a current GPS request at 224. In some examples, the GPS request utilizes a signal received from a plurality of satellites to determine the geographic location, altitude, and a velocity of the device through a calculation. In these examples, the device includes a GPS receiver to receive the signals from the plurality of satellites to perform a calculation to determine a current geographic location, current altitude, and/or current velocity of the device.

In some examples, the method 220 includes comparing the current location, current altitude, and/or current velocity to a previous location, previous altitude, and/or previous velocity captured by the device at 226. In some examples, the previous location, previous altitude, and/or previous velocity is captured at a designated time (e.g., predetermined time, known time, etc.) prior to capturing the current location, current altitude, and/or current velocity. In this way, the difference between the current GPS information (e.g., current location, current altitude, current velocity, etc.) and the previous GPS information (e.g., previous location, previous altitude, previous velocity, etc.) can be utilized with the time period to determine a difference overtime. In some examples, the difference over time is utilized to determine when the device is within a particular geographic location or headed to a particular geographic location that restricts wireless transmissions. In these examples, the difference over time is also utilized to identify velocity and/or altitude changes that can be utilized to determine when the device is on a transportation vehicle that restricts particular wireless transmissions.

In some examples, the method 220 includes determining whether the GPS location of the device is near an airport at 228. In some examples, the difference between the previous location and the current location can indicate when the device is headed to an airport. In other examples, the difference between the current location and the previous location can indicate that the device is within the area of an airport for an extended period of time, which can indicate that the device is within the airport and not passing by the airport. For example, a single GPS scan with a single set of GPS location data can result in false positive indications that the device is at an airport or other location that includes wireless restrictions on wireless transmissions. In this example, the multiple GPS scans that are compared can result in less false positive indications and can provide more accurate indicators that the device is within an airport or other location that includes wireless restrictions.

In some examples, the method 220 includes determining when an altitude is above a threshold altitude at 230. In these examples, the threshold altitude includes 3,050 meters (e.g., 10,000 feet, etc.). In these examples, the threshold altitude includes a range of a cruising altitudes for an airplane. In this way, the altitude comparison is utilized to determine when the device is on an airplane that is at a cruising altitude. In these examples, the cruising altitude of an airplane includes wireless transmission restrictions. Thus, in these examples, the method 220 disables the transmitter at 234 when the altitude is above 3,000 meters.

In some examples, the method 220 determines when the velocity is less than a threshold velocity. For example, the threshold velocity includes a velocity of 160 kilometers per hour (e.g., 100 miles per hour, etc.) In these examples, the velocity that is less than the threshold velocity indicates that the device is on a vehicle or at a location that is not a restricted location for wireless transmission. In contrast, when the velocity is above the threshold velocity indicates that the device is on a transportation vehicle that restricts wireless transmissions. In some examples, the comparison between a current velocity and a previous velocity is utilized to determine when the device is maintaining a determined velocity to avoid false positives. The method 220 includes disabling the transmitter at 234 when the velocity is less than the threshold velocity or enabling the transmitter at 236 when the velocity is above the threshold velocity.

In some examples, the method 220 includes waiting for a period of time or waiting for a timeout to occur at 238 prior to going back to read a GPS location, altitude, and velocity at 224. In this way, the period of time or timeout period is utilized as a time difference between a first GPS read and a second GPS read. The method 220 is repeated to ensure that the transmitter is deactivated when the device is within a restricted area (e.g., area that restricts wireless transmissions, etc.) and the transmitter is activated or reactivated when the device is outside the restricted area.

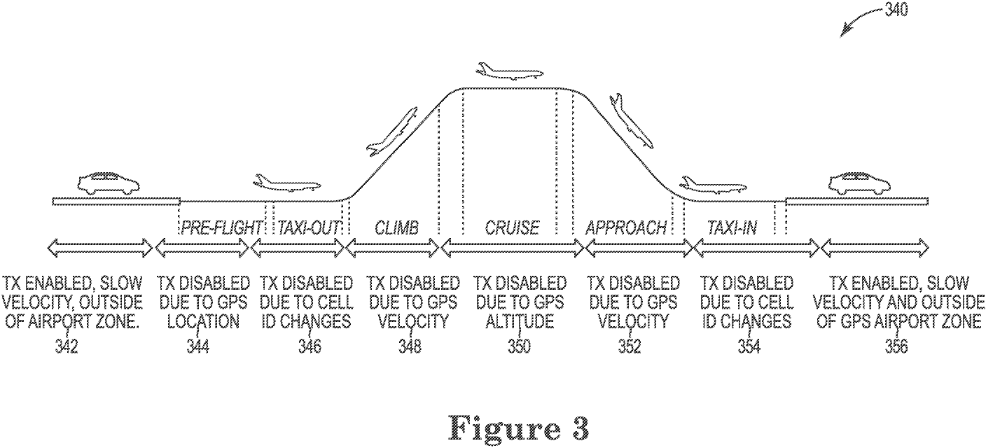

FIG. 3 illustrates an example of a method 340 for transmitter activation based on radio scans. The method 340 illustrates when a device is transported to an airport, on a flight, and away from a different airport. The method 340 is intended to illustrate the different environments that have restricted areas for wireless transmission and how the device is altered based on the environments. The device includes a computing device with a wireless transmitter utilized to transmit data to an IoT network. As described herein, the wireless transmitter may not be accessible through the device or by a user of the device. In this way, the device is capable to activate and deactivate the wireless transmitter without user interaction while not violating the wireless transmission restrictions.

The method 340 includes enabling a transmitter (TX) in response to a determination of a slow velocity and/or a determination that the geographic location of the device is outside an airport zone at 342. As described herein, an airport zone is a geographic location that restricts wireless transmissions. Although an airport zone is described in method 340, other restricted zones can be utilized in a similar way. In some examples, the velocity is determined as “slow” when the velocity is below a threshold velocity. In this way, the velocity of a car, bus, or other vehicle that allows wireless transmissions will not disable the transmitter.

The method 340 includes disabling the transmitter in response to a GPS location identifying the device is within a restricted area such as the airport at 344. As described herein, a GPS location is performed by the device utilizing a GPS receiver. In these examples, the GPS receiver from the device receives a signal from a plurality of GPS satellites that is utilized to determine a geographic location of the device. When it is determined that the device is within the area of an airport or other restricted area the transmitter is disabled. In these examples, the transmitter is disabled during a pre-flight time period. For example, the transmitter for data that is provided to an IoT network is disabled when the device is within the airport and/or when the device is within a perimeter of the airport.

In some examples, the method 340 includes disabling the transmitter in response to cellular identification (ID) changes. As described herein, a cellular scan is performed by the transmitter or a cellular device to determine a plurality of cellular IDs from a plurality of cellular devices within the area. In these examples, a previous cellular scan with a previous list of cellular IDs is compared to a current cellular scan with a current list of cellular IDs to determine a quantity of differences between the previous list of cellular IDs to the current list of cellular IDs. In some examples, a threshold quantity of differences indicates that the device is moving at a velocity that is greater than a threshold velocity. This is determined based on a location of the plurality of cellular device and/or a time period between the previous scan and the current scan. In some examples, a difference of cellular IDs below the threshold quantity indicates that the device is not moving at the velocity that is greater than the threshold. In these examples, the difference of cellular IDs may exceed the threshold difference when the device is on an airplane that is in a pre-flight or taxi-out stage of a flight. For example, the airplane may be moving from a gate to an air strip to take off at a velocity that can make the difference of cellular IDs exceed the threshold difference.

In some examples, the method 340 includes disabling the transmitter due to a GPS velocity at 348. In some examples, the velocity of the airplane taking off or moving from the ground to a cruising altitude can exceed a threshold velocity of the device. In these examples, the GPS velocity detected at the device and/or the difference between the previous GPS velocity and a current GPS velocity indicates that the device is in a climb to a cruising altitude. In these examples, the GPS velocity indicates that the device is on a transportation vehicle that restricts wireless transmissions.

In some examples, the method 340 includes disabling the transmitter due to GPS altitude at 350. In some examples, the GPS altitude indicates that the device is on an airplane that has reached a cruising altitude. In these examples, the determination from the device indicates that the device is on an airplane or vehicle that restricts wireless transmissions. Thus, the transmitter for IoT transmissions is disabled since the transmitter may not be disabled by a user of the device.

In some examples, the method 340 disables the transmitter due to GPS velocity at 352 when the airplane is descending to land. The velocity may be detected by the GPS receiver of the device and in response the device deactivates the transmitter or ensures that the transmitter is deactivated. In a similar way the transmitter may be disabled or continued to be disabled when the cellular ID changes are above a threshold at 354. As described herein, the change or difference in cellular IDs from a first scan to a second scan may indicate that the airplane is moving from a runway to a gate. In this way, the transmitter is disabled or continued to be disabled.

The method 340 includes enabling the transmitter when the velocity is below a threshold velocity and/or outside the airport zone at 356. As described herein, the transmitter may not be enabled or disabled by the user of the device and thus may be enabled or disabled based on the metrics of the cellular scan or GPS scan. In this way, the transmitter for IoT communication remains inaccessible to a user of the device while the device complies with wireless transmission restricted areas such as an airport.

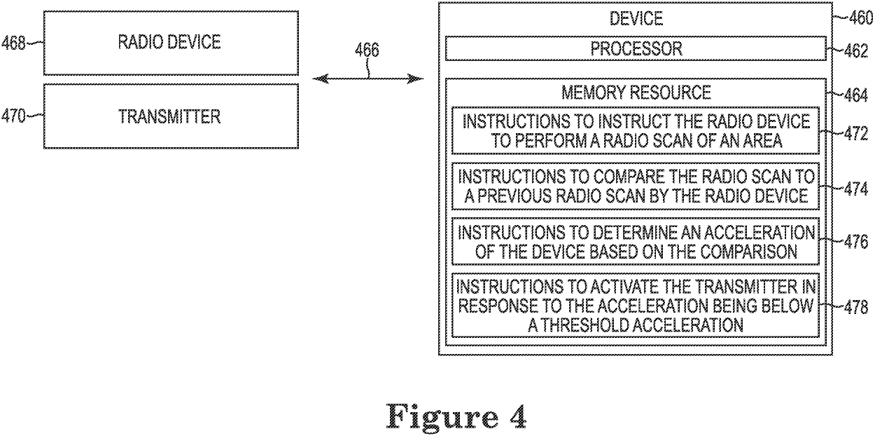

FIG. 4 illustrates an example of a device 460 for transmitter activation based on radio scans. In some examples, the device 460 is a computing device that includes a processor 462 and a memory resource 464 to store instructions that are executed by the processor 462. In some examples, the device 460 includes a processor 462 and a memory resource 464 storing instructions 472, 474, 476, 478, that can be executed by the processor 462 to perform particular functions. In some examples, the device 460 is communicatively coupled to a radio device 468 and/or transmitter 470 through a communication path 466. In some examples, the communication path 466 allows the device 460 to send and receive signals (e.g., communication signals, electrical signals, etc.) with the radio device 468 and/or the transmitter 470. In some examples, the device 460 is able to execute the methods described herein.

In some examples, the radio device 468 is capable of performing a scan of devices within the area of the radio device 468. In some examples, the radio device 468 is a cellular or wireless radio that transmits and/or receives wireless signals with other devices. In some examples, the radio device 468 is a cellular device that sends a broadcast to devices within an area and receives a response message from the devices with a corresponding cellular identification of the devices. In other examples, the radio device 468 determines a signal strength between the radio device 468 and the devices within the area. In other examples, the radio device 468 is a network radio that determines a SSID for a plurality of devices connected to a particular network. In these examples, the radio device 468 determines scan data associated with the scan performed by the radio device 468 that can be stored with location information associated with the device 460.

The device 460 includes instructions 472 stored by the memory resource 464 that is executed by the processor 462 to instruct the radio device 468 to perform a radio scan of an area. As used herein, a radio scan includes a wireless transmission of a broadcast to a plurality of surrounding devices that are capable of receiving the radio scan. In these examples, the plurality of devices respond with a data packet that identifies the corresponding device identification. For example, the instructions 472 are executed by processor 462 to instruct the radio device 468 to perform a radio scan that sends a broadcast signal to a plurality of devices and the plurality of devices respond with a corresponding response message. In these examples, the corresponding response message includes an identification of the device that responded with the response message.

The device 460 includes instructions 474 stored by the memory resource 464 that is executed by the processor 462 to compare the radio scan to a previous radio scan by the radio device 468. In some examples, the radio scan includes information received from a plurality of surrounding devices in response to the radio scan. In these examples, a current radio scan is compared to a previous radio scan to determine location information related to the device 460. For example, the previous scan is compared to a current scan to determine whether the device 460 is within a restricted area for wireless transmissions or on a transportation vehicle that restricts wireless transmissions.

In some examples, the device 460 includes instructions to compare a first signal strength associated with the radio scan to a second signal strength associated with the previous radio scan. In these examples, a difference between the first signal strength and the second signal strength indicates the acceleration of the device. In some examples, the first signal strength corresponds to a signal strength between the device and a plurality of surrounding cellular devices. In these examples, the plurality of surrounding cellular devices may have known locations and the known locations are utilized to determine a velocity of the device. For example, the velocity of the device is calculated based on a time difference between the first scan and the second scan and a distance traveled for the device is calculated based on the difference between the first signal strength and the second strength. For example, a difference in signal strength for a particular cellular device at a particular location is utilized to determine a difference in a distance between the device 460 and the particular cellular device. In this way, the difference in signal strength between the device 460 and a plurality of cellular devices is utilized to determine a velocity and direction of travel for the device 460 over the period of time between the first scan and the second scan.

In some examples, the device 460 includes instructions to activate the transmitter 470 in response to a difference between the first signal strength and the second signal strength being below a threshold value. In these examples, the device 460 includes instructions to deactivate the transmitter 470 in response to the difference between the first signal strength and the second signal strength being above the threshold value. In some examples, the difference between the first signal strength and the second signal strength being below the threshold value indicates that the device 460 is traveling at an acceleration that is below a threshold acceleration.

In some examples, the device 460 traveling below the threshold acceleration indicates that the device 460 is not on a transportation vehicle that restricts wireless transmissions. For example, the device 460 may be traveling in a car or bus that allows wireless transmissions when the velocity is below the threshold acceleration and the device 460 may be traveling on an airplane or high-speed train when the velocity is above the threshold acceleration. In this way, the transmitter 470 is deactivated when the difference between the first signal strength and the second signal strength is above the threshold value and activated when the difference between the first signal strength and the second signal strength is below the threshold value.

In some examples, the device 460 includes instructions to compare a first list of cell identifications associated with the radio scan to a second list of cell identifications associated with the previous radio scan. As described herein, a radio scan is performed by a radio device 468. The radio scan is utilized to determine a list of a plurality of devices (e.g., cell towers, static devices, etc.) within a particular area of the device 460. For example, the device 460 instructs the radio device 468 to send a message to cell towers to respond with an identification message. In this example, the device 460 generates the list of cell identifications based on received identification messages from the cell towers. In some examples, the list of cell identifications from the first scan is compared to the second scan to determine a quantity of similar cellular identifications and/or a quantity of different cellular identifications. In some examples, the differences between the first scan and the second scan are utilized to determine a distance traveled by the device 460 over a period of time between the first scan and the second scan. In a similar way as the signal strength differences between the first scan and the second scan, a velocity may be calculated for the device 460 to determine if the device is on a transportation vehicle that restricts wireless transmissions.

The device 460 includes instructions 476 stored by the memory resource 464 that is executed by the processor 462 to determine an acceleration of the device 460 based on the comparison. As described herein, the acceleration of the device 460 is calculated based on the comparison between the first scan and the second scan utilizing the differences over the period of time between the first scan and the second scan.

The device 460 includes instructions 478 stored by the memory resource 464 that is executed by the processor 462 to activate the transmitter 470 in response to the acceleration being below a threshold acceleration. As described herein, the transmitter 470 is utilized to transmit data to an internet of things (IoT) network. That is, the transmitter 470 may transmit data associated with the device 460 without instruction or notification to a user of the device 460. In some examples, a user interface of the device 460 may not have access to enabling or disabling the transmitter 470. In this way, the transmitter 470 may be enabled when the acceleration of the device 460 indicates that the device 460 is not traveling on a vehicle that restricts wireless transmissions by the transmitter 470.

In some examples, the device 460 includes instructions to deactivate the transmitter 470 in response to the acceleration being above the threshold acceleration. In this way, the device 460 deactivates the transmitter 470 in response to a determination that the device 460 is traveling on a vehicle, such as an airplane, that restricts wireless transmissions by the transmitter 470. In this way, the device 460 is able to be utilized on the vehicle with wireless transmission restrictions without providing access to a user of the device 460 to manually deactivate the transmitter 470 through a user interface of the device 460.

As described herein, the device 460 includes a processor 462 communicatively coupled to a memory resource 464 through a communication path. As used herein, the processor 462 can include, but is not limited to: a central processing unit (CPU), an application specific integrated circuit (ASIC), a field programmable gate array (FPGA), a metal-programmable cell array (MPCA), a semiconductor-based microprocessor, or other combination of circuitry and/or logic to orchestrate execution of instructions 472, 474, 476, 478. In other examples, the device 460 includes instructions 472, 474, 476, 478, stored on a machine-readable medium (e.g., memory resource 464, non-transitory computer-readable medium, etc.) and executable by a processor 462. In a specific example, the processor 462 utilizes a non-transitory computer-readable medium storing instructions 472, 474, 476, 478, that, when executed, cause the processor 462 to perform corresponding functions.

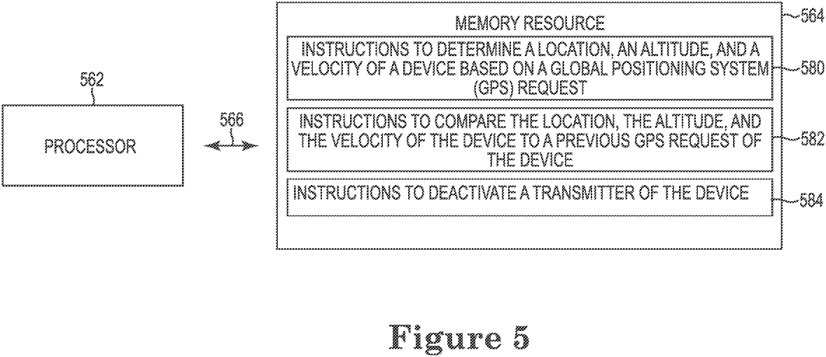

FIG. 5 illustrates an example of a memory resource 564 for transmitter activation based on radio scans. In some examples, the memory resource 564 can be a part of a computing device or controller that can be communicatively coupled to a computing system. For example, the memory resource 564 can be part of a device 460 as referenced in FIG. 4. In some examples, the memory resource 564 can be communicatively coupled to a processor 562 that can execute instructions 580, 582, 584, stored on the memory resource 564. For example, the memory resource 564 can be communicatively coupled to the processor 562 through a communication path 566. In some examples, a communication path 566 can include a wired or wireless connection that can allow communication between devices and/or components within a single device.

The memory resource 564 may be electronic, magnetic, optical, or other physical storage device that stores executable instructions. Thus, a non-transitory machine-readable medium (MRM) (e.g., a memory resource 564) may be, for example, a non-transitory MRM comprising Random-Access Memory (RAM), read-only memory (ROM), an Electrically-Erasable Programmable ROM (EEPROM), a storage drive, an optical disc, and the like. The non-transitory machine-readable medium (e.g., a memory resource 564) may be disposed within a controller and/or computing device. In this example, the executable instructions 580, 582, 584, can be “installed” on the device. Additionally, and/or alternatively, the non-transitory machine-readable medium (e.g., a memory resource) can be a portable, external, or remote storage medium, for example, that allows a computing system to download the instructions 580, 582, 584, from the portable/external/remote storage medium. In this situation, the executable instructions may be part of an “installation package”.

In some examples, the memory resource 564 can include instructions 580 to determine a location, an altitude, and a velocity of a device based on a global positioning system (GPS) request. In some examples, the GPS request is a request of a GPS system to provide a plurality of signals from satellites. The signals from the plurality of satellites are utilized to calculate the location, altitude, and velocity of the device. In some examples, the calculation is performed based on a time of flight of the plurality of signals and a location of the corresponding plurality of satellites.

In some examples, the memory resource 564 can include instructions 582 to compare the location, the altitude, and the velocity of the device to a previous GPS request of the device. In some examples, a current location is compared to a previous location to determine a change in the geographic location between the first GPS request and the previous GPS request. The change or difference in the geographic location between the first GPS request and the second GPS request is utilized to determine when the device is within an area that includes restrictions for wireless transmissions. In some examples, a current altitude from a current GPS request is compared to a previous altitude from a previous GPS request. In these examples, the altitude from the GPS request may be confirmed from the difference between the current altitude and the previous altitude. As described herein, the confirmed altitude is utilized to determine whether the device is on an airplane that is at a cruising altitude. In a similar way, the current velocity is compared to a previous velocity to confirm the velocity of the device and the confirmed velocity is utilized to determine when the device is on a vehicle that restricts wireless transmissions.

In some examples, the memory resource 564 can include instructions 584 to deactivate a transmitter of the device in response to one of the location, the altitude, and the velocity comparisons are outside a corresponding threshold value. In some examples, one of the location, the altitude, or the velocity comparisons triggers the transmitter to be deactivated. In this way, the transmitter may be deactivated when the device is within the geographic location of an airport, on an airplane that is ascending to cruising altitude, at cruising altitude, and/or descending to land. As described herein, the transmitter of the device is a transmitter utilized to provide data to an internet of things (IoT) network. In some examples, the transmitter is restricted from being manually deactivated by a user of the device.

In some examples, the memory resource 564 includes instructions to determine when the location comparison is within a geographic location that restricts wireless transmissions. As described herein, an airport may include specific areas where wireless transmissions are not allowed. In some examples, the memory resource 564 includes instructions to determine when the velocity of the device is above a velocity threshold that corresponds to a transportation vehicle that restricts wireless transmissions. In some examples, the memory resource 564 includes instructions to determine when the altitude of the device is above an altitude threshold that corresponds to a transportation vehicle that restricts wireless transmissions. For example, an airplane at the airport may restrict wireless transmissions from being performed by devices and may utilize a velocity and/or altitude that indicates when the device is on a flight. Other geographic areas may also include similar restrictions. In this way, the geographic locations or areas are identified and when it is determined the device is within the corresponding geographic areas, the transmitter is disabled from transmitting data to the internet of things network.

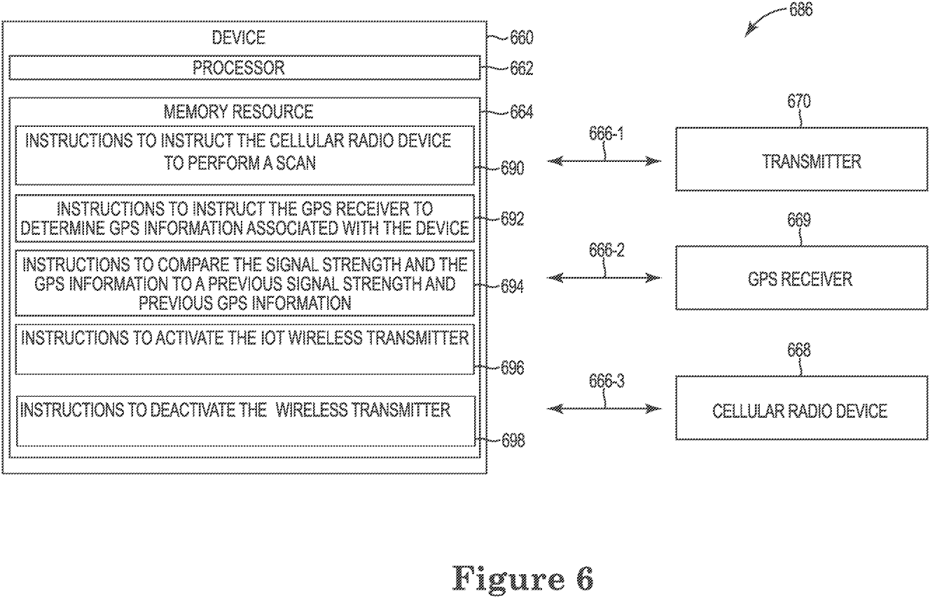

FIG. 6 illustrates an example of a system 686 for transmitter activation based on radio scans. In some examples, the system 686 includes a device 660 that includes a processor 662 communicatively coupled to a memory resource 664. In some examples, the device 660 can include a computing device that includes a processor 662 and a memory resource 664 storing instructions 690, 692, 694, 696, 698, that are executed by the processor 662 to perform particular functions.

In some examples, the system 686 includes a transmitter 670 communicatively coupled to the device 660 through a first communication path 666-1, a global positioning system (GPS) receiver 699 communicatively coupled through a second communication path 666-2, and/or a cellular radio device 668 communicatively coupled to the device 660 through a third communication path 666-3. An transmitter 670 includes a radio device utilized to transmit data for an IoT device and/or when the device 660 is in an IoT mode. In some examples, the transmitter 670 is a wireless transmitter that is not adjustable by the device 660 or directly by a user of the device 660. For example, the transmitter 670 may not be activated or deactivated through a user interface of the device 660. In some examples, the transmitter 670 is activated or deactivated by a remote device through a network connection with the device 660. As described herein, the transmitter 670 is inaccessible through a user interface of the device 660.

A GPS receiver 699 includes a satellite location system that is utilized to determine a location of a device 660 based on communication with a satellite or a plurality of satellites. For example, the GPS receiver 699 is capable of receiving signals from a plurality of satellites and utilizes time of flight or other metrics to determine a distance between the device 660 and the plurality of satellites to determine a location (e.g., physical location, geographic location, geographic coordinate, etc.).

In some examples, the system 686 includes a cellular radio device 668 communicatively coupled through the third communication path 666-3. In some examples, the cellular radio device 668 is a device to send and receive cellular signals with other devices that send and receive cellular signals. In some examples, the cellular radio device 668 is capable of sending cellular signal scans or broadcast signals that are utilized to identify a plurality of devices within an area based on responses to the broadcast signals. In this way, other devices that include a cellular radio device capable of receiving the broadcast signal and responding to the broadcast signal.

The device 660 includes instructions 690 stored by the memory resource 664 that can be executed by the processor 662 to instruct the cellular radio device 668 to perform a scan to determine a signal strength between the cellular radio device 668 and surrounding access points to determine a velocity of the device 660. As described herein, the scan includes sending a broadcast message by the radio device 668 to request a cellular identification from the surrounding access points or other types of cellular devices within an area of the radio device 668. The responses from the surrounding access points is utilized to generate a list of surrounding access points and a corresponding signal strength between the cellular radio device 668 and the surrounding access points.

As described herein, a geographic location of the surrounding access points may be known by the device 660 or determined based on information from the response messages. In some examples, the geographic location of the surrounding access points, a difference in signal strength between the cellular radio device 668, and/or the time period between a first scan a second scan is utilized to determine the velocity of the device 660.

The device 660 includes instructions 692 stored by the memory resource 664 that can be executed by the processor 662 to instruct the GPS receiver 699 to determine GPS information associated with the device 660. As described herein, the GPS information includes a geographic location, altitude, and/or velocity of the device 660. In some examples, the GPS receiver 699 is able to receive signals from a plurality of satellites to determine the GPS information associated with the device 660.

The device 660 includes instructions 694 stored by the memory resource 664 that can be executed by the processor 662 to compare the signal strength and the GPS information to a previous signal strength and previous GPS information. As described herein, the current signal strength and GPS information is compared to the previous signal strength and previous GPS information to avoid false positives or false negatives. In addition, the comparison is utilized to determine when the device 660 is in a restricted area or on a restricted transportation vehicle as described herein.

The device 660 includes instructions 696 stored by the memory resource 664 that can be executed by the processor 662 to activate the wireless transmitter 670 when the GPS information indicates the device 660 is outside a restricted geographic location or the velocity of the device is below a threshold velocity. As described herein, the wireless transmitter 670 is a designated transmitter for providing data to an IoT network. In these examples, the wireless transmitter 670 may be inaccessible and thus is to be activated or deactivated without human interaction based on the GPS information.

The device 660 includes instructions 698 stored by the memory resource 664 that can be executed by the processor 662 to deactivate the wireless transmitter 670 when the GPS information indicates the device 660 is within the restricted geographic location or the velocity of the device is above the threshold velocity. As described herein, the wireless transmitter 670 is deactivated or prevented from transmitting data to an IoT network when the device 660 is determined to be in a restricted geographic location or on a vehicle with wireless transmission restrictions. In some examples, the device 660 includes instructions to determine the velocity is above the threshold velocity when the difference between the signal strength is above a threshold difference and the velocity is below the threshold velocity when the difference between the signal strength is below the threshold difference.

In some examples, the device 660 includes instructions to deactivate the wireless transmitter 670 when the GPS information indicates an altitude of the device 660 is greater than a threshold altitude. As described herein, the threshold altitude corresponds to a cruising altitude of an airplane to automatically deactivate the wireless transmitter 670 when the threshold is greater than the threshold altitude, which indicates the device 660 is on an airplane.

In some examples, the device 660 includes instructions to determine the velocity is above the threshold velocity when the difference between the signal strength is above a threshold difference and the velocity is below the threshold velocity when the difference between the signal strength is below the threshold difference. In some examples, the device 660 includes instructions to determine a signal strength difference between the signal strength and the previous signal strength and activate the wireless transmitter 670 when the signal strength difference is less than a threshold difference. As described herein, the threshold velocity corresponds to a vehicle that includes wireless transmission restrictions. For example, the threshold velocity corresponds to a velocity of an airplane that is taking off or landing.

In the foregoing detailed description of the disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the disclosure. Further, as used herein, “a” refers to one such thing or more than one such thing.

The figures herein follow a numbering convention in which the first digit corresponds to the drawing figure number and the remaining digits identify an element or component in the drawing. For example, reference numeral 102 may refer to element 102 in FIG. 1 and an analogous element may be identified by reference numeral 302 in FIG. 3. Elements shown in the various figures herein can be added, exchanged, and/or eliminated to provide additional examples of the disclosure. In addition, the proportion and the relative scale of the elements provided in the figures are intended to illustrate the examples of the disclosure, and should not be taken in a limiting sense.

It can be understood that when an element is referred to as being “on,” “connected to”, “coupled to”, or “coupled with” another element, it can be directly on, connected, or coupled with the other element or intervening elements may be present. In contrast, when an object is “directly coupled to” or “directly coupled with” another element it is understood that are no intervening elements (adhesives, screws, other elements) etc.

The above specification, examples, and data provide a description of the system and methods of the disclosure. Since many examples can be made without departing from the spirit and scope of the system and method of the disclosure, this specification merely sets forth some of the many possible example configurations and implementations.

What is claimed is:

1. A device, comprising:
a radio device;
a transmitter; and
a processor to:
instruct the radio device to perform a radio scan of an area;
compare the radio scan to a previous radio scan by the radio device;
determine an acceleration of the device based on the comparison; and
activate the transmitter in response to the acceleration being below a threshold acceleration.

2. The device of claim 1, wherein the processor is to deactivate the transmitter in response to the acceleration being above the threshold acceleration.

3. The device of claim 1, wherein the processor is to compare a first list of cell identifications associated with the radio scan to a second list of cell identifications associated with the previous radio scan.

4. The device of claim 1, wherein the processor is to compare a first signal strength associated with the radio scan to a second signal strength associated with the previous radio scan.

5. The device of claim 4, wherein a difference between the first signal strength and the second signal strength indicates the acceleration of the device.

6. The device of claim 4, wherein the processor is to activate the transmitter in response to a difference between the first signal strength and the second signal strength being below a threshold value.

7. The device of claim 6, wherein the processor is to deactivate the transmitter in response to the difference between the first signal strength and the second signal strength being above the threshold value.

8. A non-transitory memory resource storing machine-readable instructions stored thereon that, when executed, cause a processor of a computing device to:
determine a location, an altitude, and a velocity of a device based on a global positioning system (GPS) request;
compare the location, the altitude, and the velocity of the device to a previous GPS request of the device; and
deactivate a transmitter of the device in response to one of the location, the altitude, and the velocity comparisons are outside a corresponding threshold value.

9. The memory resource of claim 8, wherein the transmitter of the device is a transmitter to send data to an internet of things (IoT) network.

10. The memory resource of claim 9, wherein the transmitter is restricted from being manually deactivated.

11. The memory resource of claim 8, wherein the processor is to determine when the location comparison is within a geographic location that restricts wireless transmissions.

12. The memory resource of claim 8, wherein the processor is to determine when the velocity of the device is above a velocity threshold that corresponds to a transportation vehicle that restricts wireless transmissions.

13. The memory resource of claim 8, wherein the processor is to determine when the altitude of the device is above an altitude threshold that corresponds to a transportation vehicle that restricts wireless transmissions.

14. The memory resource of claim 8, wherein the processor is to activate the transmitter of the device in response to the location, the altitude, and the velocity comparisons being within the corresponding threshold value.

15. A device, comprising:
a wireless transmitter;
a cellular radio device;
a global positioning system (GPS) receiver; and
a processor to:
instruct the cellular radio device to perform a scan to determine a signal strength between the cellular radio device and surrounding access points to determine a velocity of the device;
instruct the GPS receiver to determine GPS information associated with the device;
compare the signal strength and the GPS information to a previous signal strength and previous GPS information;
activate the wireless transmitter when the GPS information indicates the device is outside a restricted geographic location or the velocity of the device is below a threshold velocity; and
deactivate the wireless transmitter when the GPS information indicates the device is within the restricted geographic location or the velocity of the device is above the threshold velocity.

16. The device of claim 15, wherein the processor is to deactivate the transmitter when the GPS information indicates an altitude of the device is greater than a threshold altitude.

17. The device of claim 15, wherein the wireless transmitter is inaccessible through a user interface of the device.

18. The device of claim 15, wherein the processor is to determine the velocity is above the threshold velocity when the difference between the signal strength is above a threshold difference and the velocity is below the threshold velocity when the difference between the signal strength is below the threshold difference.

19. The device of claim 15, wherein the processor is to determine a signal strength difference between the signal strength and the previous signal strength.

20. The device of claim 19, wherein the processor is to activate the wireless transmitter when the signal strength difference is less than a threshold difference.
